(19) United States
(12) Patent Application Publication
(10) Pub. No.: US 2026/0279937 A1
(43) Pub. Date: Sep. 17, 2026

(54) BATTERY MODULE AND CHARGING CONTROL METHOD FOR LITHIUM-METAL SECONDARY BATTERY

(71) Applicant: HONDA MOTOR CO., LTD., Tokyo (JP)

(72) Inventor: Kota Ogasawara, Wako-shi (JP)

(21) Appl. No.: 19/454,477

(22) Filed: Jan. 21, 2026

(30) Foreign Application Priority Data
Feb. 10, 2025 (JP) 2025-019948

(51) Int. Cl. H01M 10/44; H01M 10/052; H01M 10/42; H01M 10/48; H02J 7/90

(52) U.S. Cl. CPC H01M 10/44; H01M 10/052; H01M 10/425; H01M 10/48; H02J 7/973

(57) ABSTRACT

A battery module includes a lithium-metal secondary battery including an electrode assembly including a negative electrode including lithium metal or a lithium alloy, a controller configured to control a charging current of the lithium-metal secondary battery, a measurement part configured to measure a surface pressure of the lithium-metal secondary battery, and a first setting part configured to set the charging current of the lithium-metal secondary battery according to the surface pressure of the lithium-metal secondary battery.

### CROSS-REFERENCE TO RELATED APPLICATION

Priority is claimed on Japanese Patent Application No. 2025-019948, filed Feb. 10, 2025, the content of which is incorporated herein by reference.

### BACKGROUND OF THE INVENTION

### Field of the Invention

The present invention relates to a battery module and a charging control method for a lithium-metal secondary battery.

### Description of Related Art

A lithium-metal secondary battery is a secondary battery using lithium metal for a negative electrode. When lithium metal is used, a thickness of a negative electrode can be decreased, and an energy density can be increased.

Unlike a graphite-based negative electrode in the related art, a negative electrode including lithium metal or a lithium alloy changes in thickness through charging and discharging, and a thickness thereof can be measured as a surface pressure. When lithium is deposited from a negative electrode including lithium metal or a lithium alloy through charging of a lithium-metal secondary battery and the negative electrode including lithium metal or a lithium alloy is made to be porous, it is known that a pressure of an electrode surface (a surface pressure) of the negative electrode including lithium metal or a lithium alloy increases. When the negative electrode including lithium metal or a lithium alloy is made to be porous, deterioration of the negative electrode including lithium metal or a lithium alloy may be caused. A method of curbing deterioration of a negative electrode including lithium metal or a lithium alloy by charging a lithium-metal secondary battery while detecting a surface pressure of the lithium-metal secondary battery is known (for example, see Published Japanese Translation No. 2023-551995 of the PCT International Publication).

### SUMMARY OF THE INVENTION

An aspect of the present invention is to provide a battery module and a charging control method for a lithium-metal secondary battery that can charge the lithium-metal secondary battery while curbing deterioration in a capacity and to contribute to stabilization of battery performance and an increase in energy efficiency.

A battery module and a charging control method for a lithium-metal secondary battery according to an aspect of the present invention employ the following configurations.

(1) A battery module includes: a lithium-metal secondary battery including an electrode assembly including a negative electrode including lithium metal or a lithium alloy; a controller configured to control a charging current of the lithium-metal secondary battery; a measurement part configured to measure a surface pressure of the lithium-metal secondary battery; and a first setting part configured to set the charging current of the lithium-metal secondary battery according to the surface pressure of the lithium-metal secondary battery.

According to this aspect, by setting the charging current according to the surface pressure of the lithium-metal secondary battery using the first setting part, it is possible to charge the lithium-metal secondary battery while curbing growth of dendrite.

(2) The battery module according to the aspect of (1) may further include a second setting part configured to set the charging current of the lithium-metal secondary battery according to a resistance of the lithium-metal secondary battery during charging.

According to this aspect, by setting the charging current for curbing an increase in thickness of the negative electrode including lithium metal or a lithium alloy, it is possible to charge the lithium-metal secondary battery while curbing deterioration in capacity of the lithium-metal secondary battery due to electrodeposition of lithium ions from the negative electrode including lithium metal or a lithium alloy.

(3) In the battery module according to the aspect of (2), the controller may set a smaller value among the charging current set by the first setting part and the charging current set by the second setting part as a final value of the charging current of the lithium-metal secondary battery.

According to this aspect, it is possible to set the charging current for curbing growth of dendrite in the negative electrode including lithium metal or a lithium alloy or the charging current for curbing an increase in thickness of the negative electrode including lithium metal or a lithium alloy. As a result, it is possible to charge the lithium-metal secondary battery while controlling deterioration in capacity of the lithium-metal secondary battery due to electrodeposition of lithium ions from the negative electrode including lithium metal or a lithium alloy.

(4) A charging control method for a lithium-metal secondary battery including a negative electrode including lithium metal or a lithium alloy includes: a control step of controlling a charging current of the lithium-metal secondary battery; a measurement step of measuring a surface pressure of the lithium-metal secondary battery; and a first setting step of setting the charging current of the lithium-metal secondary battery according to the surface pressure of the lithium-metal secondary battery.

According to this aspect, by setting the charging current for curbing growth of dendrite in the negative electrode including lithium metal or a lithium alloy, it is possible to charge the lithium-metal secondary battery while curbing deterioration in capacity of the lithium-metal secondary battery due to electrodeposition of lithium ions from the negative electrode including lithium metal or a lithium alloy.

(5) The charging control method for a lithium-metal secondary battery according to the aspect of (4) may further include a second setting step of setting the charging current of the lithium-metal secondary battery according to a resistance of the lithium-metal secondary battery during charging.

According to this aspect, by setting the charging current for curbing an increase in thickness of the negative electrode including lithium metal or a lithium alloy, it is possible to charge the lithium-metal secondary battery while curbing deterioration in capacity of the lithium-metal secondary battery due to electrodeposition of lithium ions from the negative electrode including lithium metal or a lithium alloy.

(6) In the charging control method for a lithium-metal secondary battery according to the aspect of (4) or (5), the resistance of the lithium-metal secondary battery in the second setting step may have a largest value among values obtained by measuring a DC resistance of the lithium-metal secondary battery a plurality of times.

According to this aspect, it is possible to more accurately measure the resistance of the lithium-metal secondary battery.

(7) In the charging control method for a lithium-metal secondary battery according to the aspect of (6), the control step may include setting a smaller value among the charging current set in the first setting step and the charging current set in the second setting step as a final value of the charging current of the lithium-metal secondary battery.

According to this aspect, it is possible to set the charging current for curbing growth of dendrite in the negative electrode including lithium metal or a lithium alloy or the charging current for curbing an increase in thickness of the negative electrode including lithium metal or a lithium alloy. As a result, it is possible to charge the lithium-metal secondary battery while curbing deterioration in capacity of the lithium-metal secondary battery due to electrodeposition of lithium ions from the negative electrode including lithium metal or a lithium alloy.

According to the aspects of the present invention, it is possible to provide a battery module and a charging control method for a lithium-metal secondary battery that can charge the lithium-metal secondary battery while curbing deterioration in a capacity

### BRIEF DESCRIPTION OF THE DRAWINGS

FIG. 1 is a block diagram illustrating a battery module according to an embodiment of the present invention.

### DETAILED DESCRIPTION OF THE INVENTION

Hereinafter, an embodiment of the present invention will be described in detail with reference to the accompanying drawings.

### Battery Module

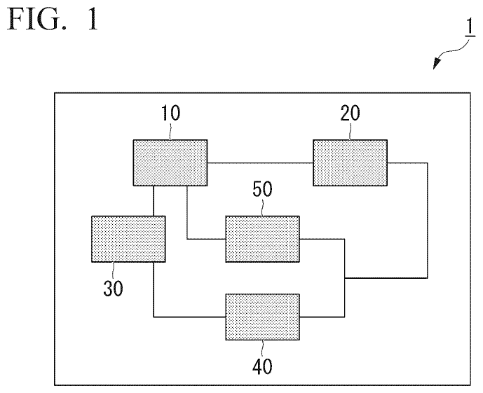

FIG. 1 is a block diagram illustrating a battery module according to an embodiment of the present invention. As illustrated in FIG. 1, a battery module 1 according to the present embodiment includes a lithium-metal secondary battery 10, a controller 20, a measurement part 30, and a first setting part 40.

The lithium-metal secondary battery 10 includes an electrode assembly. The electrode assembly includes a positive electrode, a negative electrode, and a separator and a liquid electrolyte provided between the positive electrode and the negative electrode. A solid electrolyte may be used instead of the liquid electrolyte and the separator.

### Positive Electrode

The positive electrode includes a positive-electrode collector layer and a positive-electrode active material layer. For example, aluminum can be used as a material of the positive-electrode collector layer. The positive-electrode active material layer includes a positive-electrode active material. Examples of the positive-electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganite (LiMn₂O₄), and heteroelement-substituted Li—Mn represented by Li₁₊ₓMn_{2-x-y}M_{y}O₄ (x+y=2, M=at least one selected from Al, Mg, Co, Fe, Ni, and Zn), lithium titanate (oxide including Li and Ti), and lithium metal phosphate (LiMPO₄, M=at least one selected from Fe, Mn, Co, and Ni). The positive-electrode active material layer may include various additives which are used as materials of the positive-electrode active material such as a binder and a conductive assistant.

### Negative Electrode

The negative electrode includes a negative-electrode collector layer and a negative-electrode active material layer. For example, copper can be used as a material of the negative-electrode collector layer. The negative-electrode active material layer includes a negative-electrode active material. Lithium metal or metal forming an alloy along with lithium can be used as the negative-electrode active material. Examples of the metal forming an alloy along with lithium include Mg, Si, Au, Ag, In, Ge, Sn, Pb, Al, and Zn. A carbonaceous material can be included as the negative-electrode active material. Examples of the carbonaceous material include natural graphite, artificial graphite, meso-carbon microbeads (MCMB), hard carbon, and soft carbon.

### Liquid Electrolyte

The liquid electrolyte includes an organic solvent and an electrolyte. For example, a cyclic carbonate, a chain carbonate, a cyclic ether, a chain ether, a hydrofluoroether, an aromatic ether, a sulfone, a cyclic ester, a chain carboxylic ester, and a nitrile can be used as the organic solvent. Examples of the cyclic carbonate include an ethylene carbonate, a propylene carbonate, a vinylene carbonate, and a fluoroethylene carbonate. Examples of the chain carbonate include a dimethyl carbonate, a diethyl carbonate, and an ethylmethyl carbonate. Examples of the cyclic ether include tetrahydrofuran, 2-methyl tetrahydrofuran, tetrahydropyran, 1,3-dioxolane, and 4-methyl 1,3-dioxolane. Examples of the chain ether include 1,2-dimethoxy ethane, 1,2-diethoxy ethane, ethoxymethoxy ethane, and diethyl ether. Examples of the hydrofluoro ether include 1,1,2,2-tetrafluoroethyl-2,2,2-trifluoroethyl ether, 1,1,2,2,-tetrafluoroethyl-2,2,3,3,-tetrafluoropropyl ether, bis(2,2,2-trifluoroethyl) ether, and 1,2-bis(1,1,2,2,-tetrafluoror ethoxy) ethane. Examples of the aromatic ether include anisole. Examples of the sulfone include sulfolane and methylsulfolane. Examples of the cyclic ester include γ-butyrolactone. Examples of the chain carboxylic ester include an acetic ester, an butylic ester, and a propionic ester. Examples of the nitrile include acetonitrile and propionitrile. As the organic solvent, one kind may be used alone, or two or more kinds may be used in combination.

The electrolyte is a supply source of lithium ions which are charge-transfer media and includes a lithium salt. Examples of the lithium salt include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈. As the lithium salt, one kind may be used alone, or two or more kinds may be used in combination.

### Solid Electrolyte

For example, a sulfide-based solid electrolyte can be used as the solid electrolyte. Examples of the sulfide-based solid electrolyte include Li₂S—P₂S₅, Li₂S—P₂S₅—LiI, Li₂S—P₂O₅—Li₂O, Li₂S—P₂S₅—Li₂O—LiI, LiS—SiS₂, Li₂S—SiS₂—Li, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive numbers and Z is one of Ge, Zn, and Ga), Li₂S—GeS₂, Li₂S—SiS₂—Li₃PO₄, and Li₂S—SiS₂—LiₓMO_{y} (where x and y are positive numbers and M is one of P, Si, Ge, B, Al, Ga, and In).

### Separator

A material of the separator is not particularly limited, and examples thereof include a polyolefin such as a polyethylene and a polypropylene, an aramid, a polyimide, a fluorine resin, a glass fiber, and a cellulose fiber.

The controller 20 is a device that controls a charging current of the lithium-metal secondary battery 10.

The measurement part 30 is a device that measures a surface pressure of the lithium-metal secondary battery 10. For example, a pressure sensor can be used as the measurement part 30. The surface pressure of the lithium-metal secondary battery 10 is a pressure that is generated on an electrode surface of the electrode assembly in the lithium-metal secondary battery 10. The surface pressure of the lithium-metal secondary battery 10 has a correlation with growth of dendrite in a negative electrode including lithium metal or a lithium alloy.

The first setting part 40 sets a charging current of a lithium-metal secondary battery according to the surface pressure of the lithium-metal secondary battery 10. Accordingly, by setting the charging current for curbing growth of dendrite in a negative electrode including lithium metal or a lithium alloy, it is possible to charge the lithium-metal secondary battery 10 while curbing deterioration in capacity of the lithium-metal secondary battery 10 due to electrodeposition of lithium ions from the negative electrode including lithium metal or a lithium alloy.

The battery module 1 according to the present embodiment preferably further includes a second setting part 50 configured to set the charging current of the lithium-metal secondary battery 10 according to a resistance of the lithium-metal secondary battery 10 during charging. The resistance of the lithium-metal secondary battery 10 has a correlation with a thickness of the negative electrode including lithium metal or a lithium alloy. Accordingly, by setting a charging current for curbing an increase in thickness of the negative electrode including lithium metal or a lithium alloy, it is possible to charge the lithium-metal secondary battery 10 while curbing deterioration in capacity of the lithium-metal secondary battery 10 due to electrodeposition of lithium ions from the negative electrode including lithium metal or a lithium alloy.

In the battery module 1 according to the present embodiment, the controller 20 preferably sets the smaller value among the charging current set by the first setting part 40 and the charging current set by the second setting part 50 as a final value of the charging current of the lithium-metal secondary battery 10. Accordingly, it is possible to set a charging current for curbing growth of dendrite in the negative electrode including lithium metal or a lithium alloy or a charging current for curbing an increase in thickness of the negative electrode including lithium metal or a lithium alloy. As a result, it is possible to charge the lithium-metal secondary battery 10 while controlling deterioration in capacity of the lithium-metal secondary battery 10 due to electrodeposition of lithium ions from the negative electrode including lithium metal or a lithium alloy.

In the battery module 1 according to the present embodiment, by setting the charging current of the lithium-metal secondary battery 10 according to the surface pressure of the lithium-metal secondary battery 10 using the first setting part 40, it is possible to set the charging current for curbing growth of dendrite in at least the negative electrode including lithium metal or a lithium alloy and to charge the lithium-metal secondary battery 10 while curbing deterioration in capacity of the lithium-metal secondary battery 10 due to electrodeposition of lithium ions from the negative electrode including lithium metal or a lithium alloy.

### Charging Control Method for Lithium-Metal Secondary Battery

A charging control method for a lithium-metal secondary battery according to an embodiment of the present invention is a charging control method for a lithium-metal secondary battery including a negative electrode including lithium metal or a lithium alloy, the charging control method including a control step of controlling a charging current of the lithium-metal secondary battery, a measurement step of measuring a surface pressure of the lithium-metal secondary battery, and a first setting step of setting the charging current of the lithium-metal secondary battery according to the surface pressure of the lithium-metal secondary battery.

### Control Step

In the control step, the charging current of the lithium-metal secondary battery is controlled. In the control step, the charging current is controlled such that a charging current set in the first setting step or a charging current set in a second setting step which will be described later is achieved.

### Measurement Step

In the measurement step, the surface pressure of the lithium-metal secondary battery is measured. In the measurement step, the surface pressure of the lithium-metal secondary battery is measured, for example, using a pressure sensor.

### First Setting Step

In the first setting step, the charging current of the lithium-metal secondary battery is set according to the surface pressure of the lithium-metal secondary battery acquired in the measurement step. By setting the charging current of the lithium-metal secondary battery according to the surface pressure of the lithium-metal secondary battery through the first setting step, it is possible to set a charging current for curbing growth of dendrite in a negative electrode including lithium metal or a lithium alloy and to charge the lithium-metal secondary battery while curbing deterioration in capacity of the lithium-metal secondary battery due to electrodeposition of lithium ions from the negative electrode including lithium metal or a lithium alloy. The surface pressure of the lithium-metal secondary battery has a correlation with the growth of dendrite in the negative electrode including lithium metal or a lithium alloy. Therefore, in the first setting step, the charging current is set to reach a charging current for curbing the growth of dendrite on the basis of a relationship between the surface pressure of the lithium-metal secondary battery and the degree of growth of dendrite in the negative electrode including lithium metal or a lithium alloy which has been measured in advance.

### Second Setting Step

The charging control method for a lithium-metal secondary battery according to the present embodiment preferably further includes a second setting step of setting the charging current of the lithium-metal secondary battery according to a resistance of the lithium-metal secondary battery during charging. By setting the charging current of the lithium-metal secondary battery according to the resistance of the lithium-metal secondary battery during charging through the second setting step, it is possible to set a charging current for curbing an increase in thickness of the negative electrode including lithium metal or a lithium alloy and to charge the lithium-metal secondary battery while curbing deterioration in capacity of the lithium-metal secondary battery due to electrodeposition of lithium ions from the negative electrode including lithium metal or a lithium alloy. The resistance of the lithium-metal secondary battery 10 has a correlation with the thickness of the negative electrode including lithium metal or a lithium alloy. Therefore, in the second setting step, the charging current is set to a charging current for curbing an increase in thickness of the negative electrode including lithium metal or a lithium alloy on the basis of a relationship between the resistance of the lithium-metal secondary battery during charging and the degree of increase in thickness of the negative electrode including lithium metal or a lithium alloy which has been measured in advance.

The resistance of the lithium-metal secondary battery in the second setting step preferably has a largest value among values obtained by measuring a direct-current resistance (DCR) of the lithium-metal secondary battery a plurality of times. By obtaining the largest value among the values obtained by measuring the DC resistance of the lithium-metal secondary battery a plurality of times, it is possible to more accurately measure the resistance of the lithium-metal secondary battery.

In the charging control method for a lithium-metal secondary battery according to the present embodiment, the control step preferably includes setting the smaller value among the charging current set in the first setting step and the charging current set in the second setting step as a final value of the charging current of the lithium-metal secondary battery. Accordingly, it is possible to set a charging current for curbing growth of dendrite in the negative electrode including lithium metal or a lithium alloy or a charging current for curbing an increase in thickness of the negative electrode including lithium metal or a lithium alloy. As a result, it is possible to charge the lithium-metal secondary battery while curbing deterioration in capacity of the lithium-metal secondary battery due to electrodeposition of lithium ions from the negative electrode including lithium metal or a lithium alloy.

With the charging control method for a lithium-metal secondary battery according to the present embodiment, by setting the charging current of the lithium-metal secondary battery according to the surface pressure of the lithium-metal secondary battery through the first setting step, it is possible to set the charging current for curbing growth of dendrite in the negative electrode including lithium metal or a lithium alloy and to charge the lithium-metal secondary battery while curbing deterioration in capacity of the lithium-metal secondary battery due to electrodeposition of lithium ions from the negative electrode including lithium metal or a lithium alloy.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A battery module comprising:
a lithium-metal secondary battery including an electrode assembly including a negative electrode including lithium metal or a lithium alloy;
a controller configured to control a charging current of the lithium-metal secondary battery;
a measurement part configured to measure a surface pressure of the lithium-metal secondary battery; and
a first setting part configured to set the charging current of the lithium-metal secondary battery according to the surface pressure of the lithium-metal secondary battery.

2. The battery module according to claim 1, further comprising a second setting part configured to set the charging current of the lithium-metal secondary battery according to a resistance of the lithium-metal secondary battery during charging.

3. The battery module according to claim 2, wherein the controller sets a smaller value among the charging current set by the first setting part and the charging current set by the second setting part as a final value of the charging current of the lithium-metal secondary battery.

4. A charging control method for a lithium-metal secondary battery including a negative electrode including lithium metal or a lithium alloy, the charging control method comprising:
a control step of controlling a charging current of the lithium-metal secondary battery;
a measurement step of measuring a surface pressure of the lithium-metal secondary battery; and
a first setting step of setting the charging current of the lithium-metal secondary battery according to the surface pressure of the lithium-metal secondary battery.

5. The charging control method for a lithium-metal secondary battery according to claim 4, further comprising a second setting step of setting the charging current of the lithium-metal secondary battery according to a resistance of the lithium-metal secondary battery during charging.

6. The charging control method for a lithium-metal secondary battery according to claim 5, wherein the resistance of the lithium-metal secondary battery in the second setting step has a largest value among values obtained by measuring a DC resistance of the lithium-metal secondary battery a plurality of times.

7. The charging control method for a lithium-metal secondary battery according to claim 5, wherein the control step includes setting a smaller value among the charging current set in the first setting step and the charging current set in the second setting step as a final value of the charging current of the lithium-metal secondary battery.
